(19) United States
(12) Patent Application Publication
(10) Pub. No.: US 2025/0164229 A1
(43) Pub. Date: May 22, 2025

(54) COORDINATE MEASUREMENT SYSTEM HAVING AT LEAST TWO LIMBS

(71) Applicant: HEXAGON TECHNOLOGY CENTER GMBH, Heerbrugg (CH)

(72) Inventors: Nikolay KHANENYA, St. Gallen (CH); Claudio ISELI, Au (CH); Pascal JORDIL, Ecoteaux (CH)

(73) Assignee: HEXAGON TECHNOLOGY CENTER GMBH, Heerbrugg (CH)

(21) Appl. No.: 18/911,064

(22) Filed: Oct. 9, 2024

(30) Foreign Application Priority Data
Oct. 9, 2023 (EP) 23202336.6

(51) Int. Cl. G01B 7/008; G01B 11/00

(52) U.S. Cl. CPC G01B 7/008; G01B 11/005

(57) ABSTRACT

A coordinate measuring machine (CMM) for determining spatial coordinate data of an object point on a workpiece. The CMM comprising, a first limb, a probing element, a second limb, and a coupling interface. The probing element provides probing data regarding an interaction between a sensing area and the object point. The first limb connects the sensing area to a first proximal end. The coupling interface is configured to provide coupling data regarding an interaction between a coupling area and a reference point having a defined spatial relationship to the object point. The second limb connects the sensing area to a second proximal end mechanically constrained to the first proximal end.

### FIELD

The present disclosure relates to a structure and operation of a metrology instrument, in particular a coordinate measuring machine (CMM) or a metrology robot. The instrument comprises a first limb with a probing element mounted on it, a second limb with a coupling interface mounted on it. The limbs comprise respective sets of links and joints. The CMM provides the actual pose of the probing element and the coupling interface based on sensor readings from sensors associated with the links and joints. The disclosure further relates to a method for determining the spatial coordinates of an object point on a workpiece and a respective computer program product for performing the computational steps of the method.

### BACKGROUND

CMM devices are used in a wide variety of applications in quality management and quality assurance. CMMs include stationary-, portable- or laser-based CMMs, including laser trackers, laser scanners and total stations. Metrology robots, i.e., CMMs on mobile or airborne chassis further extends the applicability of the above instruments. For the present disclosure, CMM is to be understood as an instrument configured to provide metrology grade coordinate data. Unless otherwise provided this definition covers both stationary, mobile, or airborne instruments and both tactile and non-contact data acquisition methods.

One widespread example of a basic CMM is a 3-axis system. E.g., DE 43 25 347 discloses such a system. Typically, such CMM includes a base with a measuring table and a movable frame. The workpieces might be positioned or mounted on the measuring table. The movable frame is mounted on the base such that it can move along a first axis. The frame comprises an arm mounted movably along a second axis perpendicular to the first axis. The probing element is mounted on the arm such that it can move along a third axis, which is perpendicular to the first and second axes. This construction enables the steering of the probing element in all three dimensions allowing to measure relevant 3D coordinates of an object. Contemporary 3-axis systems often comprise further components, e.g., stacked rotary tables, to provide 5 degrees of freedom regarding the relative pose of the probing element and workpiece. Throughout this document, unless expressly provided otherwise, position will be used to represent the 3D location, while pose represent a six-dimensional position and orientation information.

Another typical embodiment is the articulated arm coordinate measuring machine (AACMM). An AACMM comprises a stationary base and an arm with multiple arm segments connected by articulations. The articulations provide mobility to a movable end of the arm opposed to the base. Probing elements can be attached to the movable end. Due to the design principles AACMM-s are less accurate than the above mentioned 3- or 5-axis system, however they offer higher flexibility. E.g., EP 2 916 099 B1 discloses such an AACMM instrument.

Conventionally, highly precise CMM need to be very stable to withstand inertial distortions that may arise due to its own operating weight and—especially since fast measurements are also desirable—its movements. Conventional CMM are thus very heavy devices that are complicated to move and cannot be installed everywhere, e.g., due to weight-loading restrictions. Especially for portable CMMs lightweight design is preferable, in particular due to work safety guidelines regarding manual handling heavy items.

To achieve the required precision CMMs are often installed in dedicated metrology laboratories providing low vibration environment and strictly controlled temperature and humidity. This means, however, that in-line control of the workpieces is not possible as the CMM is located in a separate area typically far away from the manufacturing areas. This leads to a slow feedback loop and less frequent quality controlling, i.e., higher reject rate.

It would be desirable to provide a lightweight CMM that still allows highly precise measurements. It would also be desirable to provide a mobility or simplified transportability of the lightweight CMM. Mobile CMMs allow more efficient industrial processes, by reducing the need of placing bulky and costly measurement devices to each production lines. Mobile CMMs by reducing the waste rate could improve the use of raw materials and hence contributing to the establishment of circular economies.

Some aspects of the CMMs will be disclosed utilizing the terms of metrology and kinematic chains comprising respective links and joints. Unless otherwise provided “links” and “joints” are to be understood as metrology links and joints. It is assumed that metrology chains are configured to provide metrology chain data, in particular a relative pose of the endpoints of the chain with metrology grade precision.

A “metrology joint” measures the relative pose or movement of adjacent members of the metrology chain. Joints in the sense of the disclosure are to be understood in a generic manner, i.e., they encompass one degree-of-freedom rotary and linear joints, and more degrees-of-freedom joints, e.g. ball joints. Trackable areas continuously tracked by optical tracking instruments can also be joint in the sense of the disclosure. For metrology links at least a change of the geometry, in particular the absolute geometry is known. In the sense of the disclosure metrology links comprise rigid members of the limbs, in particular with known geometry, or non-rigid members whose geometry is provided. The distance between the sensing area and the object point established by e.g., an optical measurement might also be considered as a metrology link. From here on it is implicitly assumed that metrology joints and links comprise the respective sensors.

A kinematic chain is an arrangement comprising a set of kinematic links substantially transferring forces with negligible distortion, and a set of kinematic joints assembled. Kinematic links might be rigid, experiencing no distortion. Kinematic joints provide movement independently from the further members, in particular other kinematic joints. For this disclosure, kinematic links and joints are to be understood as a subtype of metrology links and joints. Rigid and substantially rigid will be used in an interchangeable manner and express that that a component is non-deformable under reasonably expected loads.

A metrology chain might comprise one or more kinematic elements arranged to one or more kinematic chains. A metrology chain might comprise further elements not comprised by a kinematic chain, in particular a measuring path with known geometry and/or a spatial relationship of the measuring probe relative to the workpiece. In the sense of the disclosure metrology loops might be closed or semi-closed arrangements of one or more metrology chains. For closed metrology loops the absolute value of each of the relevant dimensions and arrangement of their members is known. For semi-closed metrology loops at least a change of each relevant dimensions and arrangement of their members are known, e.g., they might comprise a rigid member with unknown absolute dimensions.

### SUMMARY

In view of the above circumstances, one object is to provide a CMM with more flexibility regarding the installation.

Another objective is to improve the accuracy and the repeatability of the measurements by CMMs.

Another object is to improve the time efficiency of the CMMs by providing faster measurement options retaining the precision standards.

The present disclosure relates to a CMM comprising a first limb, a probing element, a second limb, and a coupling element. CMM in the sense of the disclosure covers instruments configured to provide metrology grade coordinate data of an object point on a workpiece. The disclosure is applicable for a wide variety of CMMs in particular stationary, portable or mobile CMMs. Mobile CMMs might be realized as unmanned aerial vehicles (UAV) or as wheeled, tracked or legged, e.g., humanoid, robots configured to provide coordinate data with the respective precision.

The probing element is configured to provide probing data. The probing data comprises interaction information between a sensing area of the probing element and the object point. The probing element might comprise a tactile sensor and the probing data might comprise tactile measurement data. E.g., the probing data might comprise information regarding the relevant forces, in particular contact and friction forces, acting between the workpiece and the tactile probe. The probing data might comprise geometry information regarding the probe. The probing data might comprise information regarding an angle between the probe, in particular a measuring axis of the probe, and a derived workpiece surface and/or a derived measurement path comprising an object point whose spatial coordinate data have been acquired in a precedent step.

The probing element might be a non-contact probe, in particular a laser probe, even more particular a laser probe configured for distance measurement by triangulation, interferometry, or time of flight measurements. The probing data might comprise information regarding a distance between the sensing area, in particular a detector, and the object point. The probing data might comprise information regarding the optical properties of the workpiece surface. The probing data might comprise information regarding an angle between a measuring axis of the probe and a derived workpiece surface and/or a derived measurement path comprising an object point whose spatial coordinate data have been acquired in a precedent step and/or during the actual measuring step.

The first limb comprises a first set of joints and a first set of links. From here on it is assumed that a first set of sensors is associated with the first set of joints and links. The first limb connects the probing element at a sensing end to a first proximal end. In particular for AACMMs the first limb might be foreseen as a structure analogous to a human arm having a first set of joints providing substantially rotational movability. The disclosure is, however, not limited to this narrow interpretation of the limb and the aspects of the disclosure might be applicable to 3-axis or 5-axis CMM-s as well. The first set of joints might comprise sliding joints representing the movability of these systems.

The probing element and the first limb are functional definitions, in particular they are defined with respect to the actual measurement task. The first limb might have extensions, in particular an extension having an alternative probing or coupling element. Such extensions might be a part of the same physical component, e.g., a rigid component with a branch. A plurality of first limbs might be utilized during a measurement task sequentially or in parallel. By way of example from here on only embodiments with a single first limb are discussed in details. The specifics of further embodiments might be applied accordingly.

The disclosure is applicable to CMMs having a single probing element with a single sensing area arranged on the sensing end of a limb. The disclosure is equally applicable to CMMs with a plurality of sensing units arranged to different locations on a single limb and/or arranged to a plurality of limbs. For the disclosure the interaction surface of the sensing elements, in particular detector surfaces and/or ruby spheres or diamonds, providing probing data are considered as sensing area, whereas one or more first limbs are linking these sensing areas to the first proximal end. Inventive CMMs with a plurality of sensing elements might not use each of the sensing units to provide probing data, in particular a sensing units might provide coupling data.

The coupling interface is configured to provide coupling data comprising interaction information between the coupling area and a reference point. The object point has a defined spatial relationship to the reference point. The reference point might be comprised by the workpiece. In particular the workpiece is assumed to be rigid under the influence of the forces and moments experienced during a measurement process. Workpieces could comprise mountings temporarily arranged to the workpiece. The coupling interface might provide mechanical coupling, i.e., the coupling interface might be locked to the workpiece. The coupling interface might be configured to move the workpiece. Alternatively, the coupling interface might provide metrological coupling, i.e., the relative pose of the coupling area to the reference point is known with an accuracy corresponding to that of the CMM measurement. From here on, unless otherwise provided, coupling is used in the sense of six degrees-of-freedom coupling. Specific features of other types of coupling interfaces/data might be applied accordingly.

The second limb comprises a second set of links, and/or a second set of joints. From here on it is assumed that a second set of sensors is associated with the second set of joints and links. The second limb connects the coupling interface at a coupling end to a second proximal end. The second proximal end is mechanically constrained to the first proximal end. I.e., a movement of one of the proximal ends causes a movement of the other. The second limb might consist of a single joint or a single link for some embodiments. The second limb might comprise a plurality of joints and links and be analogous to the first limb, in particular identical. The coupling interface might be a probing element. By way of example only embodiments wherein the second limb is analogous to the first limb will be discussed in detail. Specific features of embodiments with different types of second limb might be applied accordingly. The limbs provide metrology chains between the coupling/sensing areas and the proximal ends and metrology chain data based on sensor readings of the set of sensors.

A support structure might connect the first and second proximal ends. Unlike to further auxiliary components, e.g., a mobile chassis, the support structure is considered to be a part of the metrology loop. For closed or semi-closed measurement loops the first and second limbs and the support structure are functional definitions. Whether a particular physical component is assigned to the first limb, the second limb or the support structure is, to some degree, a matter of interpretation. The CMM, in particular a controller of the CMM, is configured (i) to determine an actual pose of the sensing area, in particular based on sensor readings of the first set of sensors, (ii) to determine an actual pose of the coupling area, in particular based on sensor readings of the second set of sensors, (iii) to provide coupling pose change data based on the actual pose of the coupling area and the coupling data, and (iv) to provide the coordinate data of the object point based on the probing data, the actual pose of the sensing area, and the coupling pose change data. It is self-explanatory that the utilization of numerals and letters does not represent e.g., a sequence of performing the steps. These and all further numbers do not represent a temporal and spatial connection, not even in the form of a preferred sequence, and merely serve the purpose of readability.

In some embodiments, the first and the second proximal ends coincide. In other words, at least a part of a joint is comprised by both the first and second set of joints or at least a part of a link is comprised by both the first and second sets of links. Alternatively, a substantially rigid support structure might connect the first and second proximal ends. Such embodiments are beneficial as the metrology loop can be decoupled from environment influences, in particular from vibrations.

In some embodiments, each joint of the first set of joints comprises (i) a proximal side linked to the first proximal end by a respective proximal portion of the first limb, (ii) distal side linked to the sensing area by a respective distal portion of the first limb, and (iii) a joint sensor unit configured to provide first joint sensor data regarding a relative pose and/or pose change between the proximal and distal sides of the joint. The proximal and distal sides, especially for joints with more than one degree-of-freedom, might be represented with a plurality of equivalent models. The disclosure is not limited to a given representation of the metrology chains, in particular the joints. Each joint of the second set of joints comprises (i) a proximal side linked to the second proximal end by a respective proximal portion of the second limb, (ii) a distal side linked to the coupling area by a respective distal portion of the second limb, and (iii) a joint sensor unit configured to provide second joint sensor data regarding a relative pose and/or pose change between the proximal and distal sides of the joint. By way of example only embodiments, wherein the joints of the second set of joints are substantially similar to the first set of joints are discussed in detail. The specific features of alternative embodiments, in particular wherein a part of the joints second set of joints is less accurate and/or simpler than the joints of the first set of joints, may be applied accordingly.

In some specific embodiments, the CMM is configured to access computer generated or operator input data regarding a desired pose or movement of the sensing area. A subset of the first set of joints, in particular each joint, comprises a first drive unit configured to provide the relative pose and/or the pose change between the proximal and distal side of the joint. In other words, at least one joint of the first set of joints might be kinematic joints. The CMM is configured to provide steering commands for the first drive units based on the desired pose or movement and the actual pose of the sensing area.

In some specific embodiments, the CMM is configured to access computer generated or operator input data regarding a desired pose or movement of the coupling area. A subset of the second set of joints, in particular each joint, comprises a second drive unit configured to provide the relative pose and/or the pose change between the proximal and distal sides of the joint. I.e., at least one joint of the second set of joints might be kinematic joint. The CMM is configured to provide steering commands for the second drive units based on the desired pose or movement and the actual pose of the coupling area.

In some specific embodiments, the drive and sensor units are integrated into a common module comprising a motor circuit board, a stator, and a rotor. The rotor is configured to rotate relative to the stator about a rotation axis, wherein the rotor is controlled by the motor circuit board. The common module might comprise a gearbox to transform-according to a defined gear ratio-a rotary motion of the rotor about the rotation axis into a rotary motion of a gearbox output component about the rotation axis. The motor circuit board and the stator are arranged axially with respect to the rotation axis on one side of the gearbox, denoted gearbox input side. The gearbox output component engages the gearbox from the other side of the gearbox, denoted gearbox output side. The common module further comprises a connecting part which extends from the gearbox output side to the gearbox input side and is configured to pick up the rotation of the gearbox output component in a rigid manner, thereby providing rotation of the connecting part conforming, e.g., being identical, to the rotation of the gearbox output component. The common module further comprises a rotary encoder configured to detect a rotation of the gearbox output component about the rotation axis. The rotary encoder is arranged on the gearbox input side and configured to provide for measuring a rotation of the connecting part about the rotation axis. Combining two of the above common modules into a dual axis common module is also possible.

In some embodiments, the CMM is configured (i) to store first and second limb calibration parameters, (ii) to determine the actual pose of the sensing area based on the first limb calibration parameters, and (iii) to determine the actual pose of the coupling area based on the second limb calibration parameters. Said calibration parameters might comprise data regarding dynamic behavior of the CMM, in particular sets of deformations of the links and/or the joints when the movements of the CMM are performed with high acceleration and/or under the influence of the gravity. The calibration parameters might also comprise information regarding the thermal behavior of the respective limbs, e.g., on the influence of thermal gradients.

In some specific embodiments the CMM comprises an internal calibration object and reference-free calibration functionality. The reference-free calibration functionality comprises (i) providing a calibration pose of the internal calibration object, (ii) providing first calibration data comprising spatial coordinates of the internal calibration object in the calibration pose based on the first limb calibration parameters, (iii) providing second calibration data comprising spatial coordinates of the internal calibration object in the calibration pose based on the second limb calibration parameters, (iv) providing deviation data based on the first and second calibration data, in particular wherein the deviation data is proportional to a difference of the spatial coordinates, and (v) updating the first and/or second limb calibration parameters based on the deviation data.

In some specific embodiments, a plurality of calibration poses of the internal calibration object is provided. If a CMM has L>1 limbs, D active degrees-of-freedom per limb, A poses of end-effectors connected together, and C calibration parameters per limb, then the number of unknowns is U=L×C+A×6, while the number of knowns is K=L×A×D. If K>>U, i.e., the number of knowns significantly exceed the number of unknowns, a self-calibration is possible without a reference system. Such self-calibration is especially suitable if one of the limbs is less accurate than the other, e.g., as a result of a collision. Furthermore, such self-calibration might provide feedback regarding the calibrated state of the limbs. In some embodiments, the reference-free calibration functionality further comprises mechanically interlocking the first and second limbs. Or in alternative words, during the calibration only a constrained movement is allowed, wherein the calibrated state is represented by a deviation of zero.

In some specific embodiments the internal calibration object is (i) the sensing area, (ii) the coupling area, (iii) a second limb calibration object, in particular a calibration pattern with a plurality of calibration objects in a known spatial arrangement, arranged on the second limb, or (iv) a first limb calibration object, in particular a calibration pattern with a plurality of calibration objects in a known spatial arrangement, arranged on the first limb. The above list is non-exclusive and other embodiments might utilize different internal calibration objects. Moreover, the internal calibration object might alternate during a calibration routine. This can be especially useful for a two-step calibration routine, wherein a first step involves a calibration of a first portion of the first limb and a second step involves a calibration of a second portion partially different from the first portion.

In some embodiments, the coupling interface is configured to provide a rigid mechanical coupling between the coupling area and the reference point. The coupling data comprises data regarding the presence of the rigid mechanical coupling. In some specific embodiments, the coupling interface is configured to grip the workpiece. The CMM is configured provide steering commands for the second limb, in particular the second drive units, based on the actual pose of the coupling area and relative coordinate data of the reference point.

In some specific embodiments, the coupling interface comprises a first locking element and the workpiece comprises a second locking element associated with the reference point. The first and second locking elements are configured to provide a releasable, substantially rigid mechanical contact, in particular a permanent magnetic contact, and/or an electromagnetic contact, and/or a one-ball coupling, and/or a three ball-coupling, and/or a lock-and-key contact and/or a bolted connection.

In some specific embodiments, when rigid mechanical coupling between the coupling area and the reference point is provided the mobility for a part of the second set of joints is further reduced. In particular an immobile state for each joint in the second set of joints is established. In such embodiments the whole second limb can be considered a rigid element. An advantage of this approach is that no influence, in particular measurement noise, might arise from the second limb. Furthermore, the measurement task is simplified as only the first limb have to be controlled, this is especially advantageous during a manual measurement under direct operator control. The disclosure is, however, applicable without immobilizing the second limb or establishing a rigid mechanical coupling between the coupling interface and the workpiece.

In some embodiments, the workpiece comprises a traceable pattern, in particular an optically traceable pattern, more particularly a QR-code. A pose of the reference point is associated with a traceable patter. The CMM is configured to (i) identify the traceable patter e.g., by pattern recognition, and (ii) provide a relative pose of the coupling area to the reference point, e.g., by means of an optical distance measurement. The coupling data comprises the relative pose of the coupling area to the reference point. Such embodiments are advantageous as they allow the closing of the measurement loop without touching the workpiece. Non-contact measurements, without force applied on the workpiece are beneficial for non-rigid workpieces as it reduces the risk of workpiece deformation during the measurement. In the sense of the disclosure tracing and tracking provide an analogous effect and are used interchangeably. The coupling data might be provided by optically tracing the traceable pattern, e.g., by performing a structure from motion analysis on the images acquired.

In some embodiments, each joint of the first and second set of joints is a rotary joint, each of the links has a substantially cylindrical shape, the pose change between the respective base and the distal sides is a rotation around one or more axes, and the respective joint sensor data comprises rotation angle data. In other words, the CMM follows the design of a contemporary AACMM. Substantially cylindrical in the sense of the disclosure means that the link comprises no kinks, bends, branches, or similar structures, however they might comprise recesses, cavities, notches or similar structures. The links and/or the joints might comprise associated auxiliary components providing increased mechanical stability. Substantially cylindrical might also e.g., mean prismatic or conical shapes.

In some embodiments, the probing element comprises a tactile sensor and the probing data comprises contact and/or friction force information between the sensing area and the object point. Such embodiments provide higher accuracy and precision, the disclosure is however not limited to them.

In some embodiments, the links of the first and second set, the support structure and the workpiece are mechanically rigid, in particular the CMM is configured to access the defined spatial relationship between the object and the reference points. Such embodiments are beneficially combinable with rigid mechanical coupling between the workpiece and the coupling interface and tactile probing. I.e., a measuring loop comprising only rigid elements and joints, in particular joints providing one or more rotational degrees-of-freedom.

In some embodiments each of the links have sensors associated with them. The associated sensors are configured to provide geometry data regarding the respective link, in particular regarding a length and/or a bending of the respective link. Alternative to an ideally rigid links enabling only rigid body movements the geometry of the links might also be provided by sensor measurement. Such geometry data might be further supported by a computer modelling of the CMM.

In some embodiments, the CMM further comprises a non-contact tracking unit, in particular a laser and/or image-based tracking unit, for determining a pose of the sensing area and/or the coupling area. Such non-contact tracking unit might alternatively or additionally provide the pose of the sensing and/or the coupling area. In particular the non-contact tracking unit might provide verification measurement regarding the joint sensor data.

In some specific embodiments, the first limb and/or the probing element comprises a first six degrees-of-freedom trackable area, in particular a retroreflector or a visual marker, associated with the pose of the sensing area. Alternatively or additionally, the second limb and/or the coupling interface comprises a second six degrees-of-freedom trackable area, in particular a retroreflector or a visual marker, associated with the pose of the coupling area.

Six degrees-of-freedom trackable areas are advantageous as they allow full pose characterization of the probing element and/or the coupling interfaces. Nevertheless, for many applications obtaining the position of said components is sufficient and in some alternative embodiments the probing element and/or the coupling interface comprises three degrees-of-freedom trackable areas. Having an area configured to be cooperatively tracked by the non-contact tracking unit provides benefits for the stability and/or the accuracy of the tracking the disclosure is not limited to embodiments having trackable areas.

In some embodiments, the CMM, in particular the support structure, is configured to be mounted to a mobile chassis. The mobile chassis is configured to transport the CMM from a first location to a second location. The mobile chassis might be an unpowered trolley, a manned or unmanned ground vehicle, a UAV, or a mobile robot. Alternatively, the CMM might be man-portable.

In some specific embodiments, the CMM exhibits a transport mode and a measurement mode. In the transport mode a part of the first and/or second limb is immobile, in particular the first and second limbs are interlocked. I.e., a mobility, or total degrees-of-freedom, of the first and/or the second limb is reduced with respect to a mobility in the measurement mode. The CMM is locked to the mobile chassis. Such transport mode is beneficial as the delicate joint drives and sensors are protected against the vibrations and/or shock events experienced during the transport. Alternatively, a part of, in particular each of the joints might be idling. Furthermore, the probing element might be moved to a parking position and/or dismounted during the transport model. In the measurement mode, the CMM is mechanically decoupled from the mobile chassis such that mechanical vibrations between the mobile chassis and the CMM are dampened. The advantage of this decoupling is that even though the CMM is still arranged to the mobile chassis it can perform high accuracy measurements. Mechanical decoupling might be realized e.g., by a passive or active pneumatic dampening element between the support structure and the mobile chassis.

The present disclosure further relates to a method of determining spatial coordinate data of an object point on a workpiece by a CMM, in particular a CMM according one of the above embodiments. The method comprises (i) providing an actual pose of a sensing area associated with a sensing end of a limb comprising a first set of links and a first set of joints, (ii) providing probing data comprising interaction information between the sensing area and the object point, (iii) providing an actual pose of a coupling area associated with a coupling end of a second limb comprising a second set of links, and/or a second set of joints (iv) providing coupling data comprising interaction information between the coupling area and a reference point, in particular a reference point on the workpiece, (v) deriving coupling pose change data based on the actual pose of the coupling area and the coupling data, and (vi) providing coordinate data of the object point based on the actual pose of the sensing area, the probing data and the coupling pose change data. The object point has a defined spatial relationship to the reference point. The first proximal end of the first limb opposing to the sensing end and a second proximal end of the second limb opposing to the coupling end are mechanically constrained to each other.

Some embodiments of the method comprise providing rigid mechanical coupling between the coupling area and the reference point. In some specific embodiments, the rigid mechanical coupling is provided by gripping the workpiece with the second limb and/or the coupling interface. Alternative methods of providing the rigid mechanical coupling are also within the sense of the disclosure. A non-exclusive list of these alternatives includes a permanent magnetic contact, and/or an electromagnetic contact, and/or a one-ball coupling, and/or a three ball coupling, and/or a lock- and -key contact, and/or bolted connection. Some specific embodiments of the method further comprise reducing the mobility of the limb, e.g., by immobilizing the joints.

Some specific embodiments of the method comprise mechanically decoupling the workpiece from the environment, e.g., by lifting the workpiece by the second limb and/or the coupling interface. Such embodiments are beneficial, e.g., when the workpiece is situated on a production line, e.g., on a conveyor belt. In such cases the measurement is carried out with a higher accuracy after decoupling the workpiece from the environment. The second limb may place a workpiece into a different location after completing the measurement. I.e., the CMM might be comprised by a robot performing further tasks.

In some embodiments of the method, the actual pose of the sensing area is provided based on first limb calibration parameters and the actual pose of the coupling area is provided on the basis of second limb calibration parameters.

In some embodiments of the method, the actual pose of the sensing area is provided by deriving first metrology chain data. Deriving the first metrology chain data comprises (i) accessing first geometry data for each link of the first set, in particular by processing sensor readings associated with the respective links, (ii) accessing first joint sensor data regarding a relative pose between proximal and distal sides of the respective joints, wherein the proximal side linked to the first proximal end by a respective proximal portion of the first limb and the distal side linked to the sensing area by a respective distal portion of the first limb, and (iii) deriving the actual pose of the sensing area based on the first geometry data and the first joint sensor data.

In some embodiment of the method, the actual pose of the coupling area is provided by deriving second metrology chain data. Deriving the second metrology chain data comprises (i) accessing second geometry data for each link of the second set, in particular by processing sensor readings associated with the respective links, (ii) accessing second joint sensor data regarding a relative pose between the proximal and distal sides of the respective joints, wherein the proximal side linked to the second proximal end by a respective proximal portion of the second limb and the distal side linked to the coupling area by a respective distal portion of the second limb, and (iii) deriving the actual pose of the coupling area based on the second geometry data and the second joint sensor data.

In some embodiments, the method comprises a further measurement phase. The further measurement phase comprises (i) selecting an object point from a set of measured object points as a second reference point, (ii) providing an actual pose of the sensing area relative to the further reference point, (iii) providing further coupling data comprising interaction information between the sensing area and the further reference point, (iv) deriving further coupling pose change data based on the actual pose of the sensing area and the further coupling data, (v) providing an actual pose of the coupling area, (vi) providing further probing data comprising interaction information between the coupling area and a further object point on the workpiece, and (vii) providing coordinate data of the further object point based on the actual pose of the coupling area, the further probing data and the further coupling pose change data. In other words, in the further measurement phase the role of the sensing and coupling areas and the first and second limbs are reversed. Such embodiments are advantageous during the measurement of a large workpiece by a mobile CMM. Such measurement might be performed as a set of chain linked measurements, wherein one of the object points will be treated as a reference point for the next measurement from the set of chain linked measurements.

The present disclosure further relates to a computer program product for the CMM which, when executed by a computing unit and/or a controller, in particular a controller for a CMM, causes an automatic execution of the computational steps of a selected embodiment of the measurement method.

### BRIEF DESCRIPTION OF THE DRAWINGS

By way of example only, specific embodiments will be described more fully hereinafter with reference to the accompanying figures, wherein:

FIG. 1a shows a schematically of a prior art three-axis CMM.

FIG. 1b shows a schematically a prior art articulated arm inspection unit.

FIG. 2a depicts schematically a prior art CMM performing a measurement.

FIG. 2b shows a metrology chain during a prior art CMM measurement.

FIG. 3a depicts schematically an inventive CMM with first and second limbs, the object and reference points coincide during a measurement step.

FIG. 3b depicts a metrology chain of an inventive CMM with first and second limbs, the object and reference points coincide during a measurement step.

FIG. 4a depicts schematically an inventive CMM with first and second limbs during a generic measurement step.

FIG. 4b depicts the metrology chain of an inventive CMM with first and second limbs during a generic measurement step.

FIG. 5a depicts a flowchart of a process, wherein an inventive CMM establishing mechanical coupling between the coupling interface and the workpiece.

FIG. 5b depicts a flowchart of a process, wherein an inventive CMM establishing non-contact coupling between the coupling interface and the workpiece.

FIGS. 6a and 6b depict schematically an inventive CMM mounted to a mobile chassis in a transport mode and in a measurement mode.

FIGS. 7a-7c depict a schematic measurement process of a large object with a CMM having limbs sequentially acting as the first and second limbs.

FIGS. 8a-b depict a schematically an inventive portable CMM in a transport mode and during a measuring of a workpiece.

FIGS. 9a-c depict the schematics of a coupling based on a pose determination relative to a QR-code.

FIG. 10a depicts a schematic calibration using a calibration object arranged to the second limb.

FIG. 10b depicts a schematic calibration using the sensing and coupling areas.

FIG. 11 depicts a flowchart representation of a calibration of the limbs.

### DETAILED DESCRIPTION

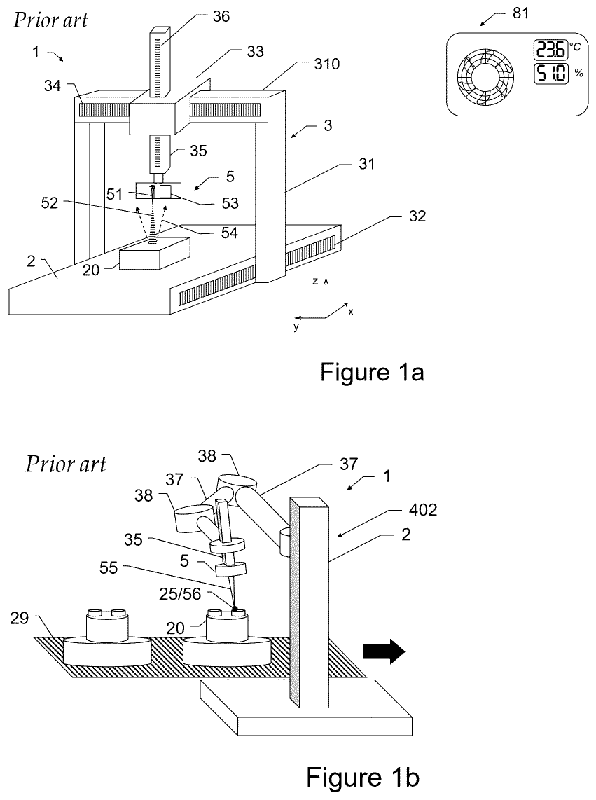

FIG. 1a shows schematically a prior art three axis CMM 1. The CMM 1 comprises a measuring table, as support structure 2, supporting a workpiece 20. While not shown, the measuring table 2 might comprise elements aiding the positioning, clamping, or otherwise fixing the workpiece 20. Such further elements might be temporarily mounted to the measuring table 2. The measuring table 2 is typically a heavy, inert object and considered to be stable during a measurement.

A movable frame is mounted on the measuring table 2 such that the girders 31 are movable along a first axis, depicted as the x-axis, by a first set of motors 32. The frame comprises a bar 310 rigidly mounted between the girders 31. A carrier 33 is mounted on the bar 310 such that it is movable by a second set of motors 34 along a second axis perpendicular to the first axis, depicted as the y-axis. The probe mounting 35 is mounted on the carrier 33 such that it is movable by a third set of motors 36 along a third axis perpendicular to both the first and second axes, depicted as the z-axis.

The probing element 5 is mounted on the probe mounting 35. The depicted probing element 5 is a non-contact probe with a beam emitter 51 emitting a primary beam 52 and a receiver 53 receiving the secondary beam 54 returned from the workpiece 20, particularly from the object point 25. In the sense of the disclosure the receiver 53 might be considered as a sensing area, the first set of joints can be identified as sliding joints comprising a motor (e.g., 35) and an associated sliding element (e.g., 36), whereas the girder 31 is a link. It is clear for the skilled person, that the in FIG. 1a depicted basic three axis setup might be extended with further components providing further degrees-of-freedom, in particular rotation degrees-of-freedom. To ensure the required accuracy for a typical prior art CMM 1 the table 2 is heavier than the first limb 3, whereas the workpiece 20 has dimensions and weights negligible as compared to table 2.

To further improve the accuracy such CMMs 1 are typically installed in dedicated metrology laboratories with an air conditioning 81 operating in a strict regime (e.g., +1° C. and +10% humidity). This is not only disadvantageous from cost and production efficiency reasons but requires further energy consumption and can therefore lead to increased greenhouse gas emissions.

FIG. 1b depicts another typical embodiment of a prior art CMM 1 as an articulated arm coordinate measuring/inspection unit. The depicted CMM 1 is placed next to a conveyor system 29, wherein workpieces 20 are travelling towards a next station. The CMM comprises a support structure 2 and a first limb 3 linked to a first proximal end 402 located on the support structure 2. The probing element 5 comprises a tactile sensor 55 with a ruby sphere as the sensing area 56. Tactile sensors 55 typically establish a direct mechanical contact between the sensing area 56 and the object point 25. The cylindrical links 38 of the first set of links and the joints 37 of the first set of joints provide a first metrology chain between the sensing area 56 and the first proximal end 402. The depicted joints 36 provide at least one relative rotational degree-of-freedom.

It is clear to the skilled person that many combinations and alternatives of the depicted embodiments exist, in particular the probing element 5 can be altered without altering the first limb 3. The embodiments depicted in FIGS. 1a-b serve solely illustrative purposes. The presently disclosure is not limited to a specific type of CMM and can be applied to any reasonable design.

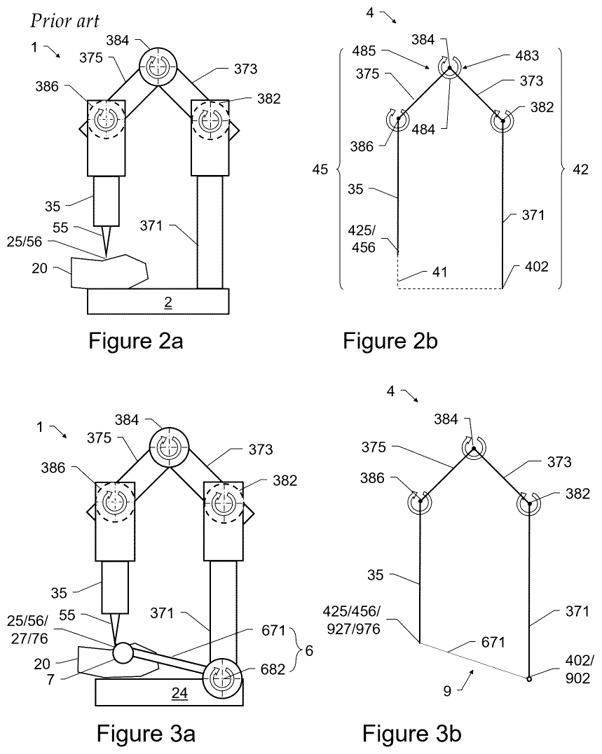

FIG. 2a shows a schematic prior art AACMM 1 performing a measurement on a workpiece 20. The AACMM 1 is mounted on a support structure 2, e.g., a measurement table and the workpiece 20 is placed on the same structure. The AACMM comprises links 371,373,375,35 and joints 382,384,386. For transparency reasons the joints 382,384,386 are depicted with only a single rotational degree-of-freedom. The first limb might comprise specific components to determine the geometry data of the links 371,373,375,35. The depicted AACMM comprises a tactile probe 55, i.e., the object point 25 is contacted with the sensing area 56 of the probe 55.

FIG. 2b depicts a first metrology chain 4 representing the same measurement process. The metrology chain 4 has a first proximal end 402 at the support structure and a sensing end 456 representing the position of the sensing area. For reasons of brevity and transparency the links 371,373,375,35 are considered rigid. Alternative embodiments comprising modeling and/or measuring certain deformations also exists in the prior art. Each joint, joint 384 shown as an example, has a proximal side 483 linked to the first proximal end 402 by a respective proximal portion 42 and distal side 485 linked to the sensing end 456 by a respective distal portion 45. A joint sensor (not shown) measures a pose and/or pose change, e.g. a rotation around a single axis, between the proximal 483 and distal sides 485. A drive unit (not shown) might provide a relative pose and/or pose change between the proximal 483 and distal sides 485. The depicted metrology chain 4 is not closed, i.e., the accuracy of the measurement depends on the assumption that a closing portion 41 of the loop, provided by the workpiece and the measurement table, is mechanically rigid. To ensure this the measurement table is ideally heavy and the workpiece is ideally clamped.

The above requirements might be realized by a CMM according to the embodiment of FIG. 1a at the cost of the bulkiness of the CMM. A coordinate measurement operation with the system depicted in FIG. 1b, let alone with a lightweight mobile CMM, however cannot fulfill these requirements. Even if a measurement is performed during a phase when the conveyor is still, the inertness of the support structure and the conveyor system cannot be guaranteed, as such system must fulfill other design criteria.

FIG. 3a depicts schematically an inventive AACMM 1 performing a measurement on a workpiece 20. The AACMM 1 is mounted on a chassis component 24, e.g., a measurement table, which is not part of the measurement loop. The AACMM 1 comprises the first set of links 371,373,375,35 and joints 382,384,386. The depicted AACMM 1 comprises a tactile probe 55, i.e., the object point 25 is contacted with the sensing area 56 of the probe 55. The inventive AACMM 1 comprises a second limb 6. The depicted second limb comprises one link 671 and one joint 682. The second limb 6 might comprise further joints and links. The second limb 6 might comprise specific components to determine the geometry data of the links 671. A coupling interface 7 is mounted to the second limb 6. The depicted coupling interface 7 further comprises gripping, clamping or suitable alternative components to provide a rigid coupling between a reference point 27 on the workpiece 20 and a coupling area 76. This enables a measurement e.g., on a lifted workpiece 20 as depicted. Nevertheless, the disclosure is applicable without a rigid coupling between the workpiece 20 and the coupling area 76. In the embodiment depicted on FIG. 3a the reference point 27 interacting with the coupling area 76 and the object point 25 interacting with the sensing area 56 are essentially the same. This serves illustrative purposes only.

FIG. 3b depicts the first 4 and second metrology chains 9 representing the same measurement process. The first metrology chain 4 has a first proximal end 402 and a sensing end 456 representing the position of the sensing area. Similarly, to FIG. 2b the links 371,373,375,35 are considered rigid. The second metrology chain 9 has a second proximal end 902 and a coupling end 976 representing the position of the coupling area. In the specific geometry depicted in FIG. 3a the proximal ends 402/902 of the first 4 and second metrology chains 9 and the sensing 456 or coupling ends 976 respectively coincide. In a general case the pose of the respective proximal ends 402 and 902 are mechanically constrained. Since both the first 4 and second metrology chains 9 are open the respective distal ends 456,976 are not constrained, i.e., the depicted case represents a situation when a closed measurement loop contains only the metrology chains 4,9.

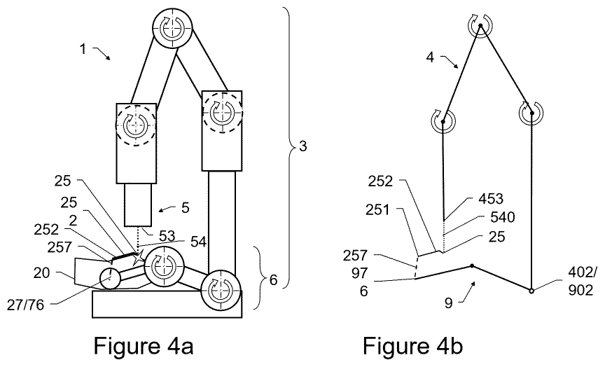

FIGS. 4a and 4b represents a more generic case. Both the first 3 and second limbs 6 comprise a plurality of links and joints. The depicted probing element 5 is an optical probe configured to detect the secondary beam 54 returned from the workpiece 20. The sensing area 53 is defined as a receiver of the probing element 5. FIG. 4a shows an intermediate stage of a measurement consisting of a plurality of measuring events along a measuring path 252. The spatial relationship between the actual 25 and initial object points 251 is known. A pose difference 257 between the reference point/coupling area 27/76 and the initial object point 251, even if unknown, is fix during the measurement process.

FIG. 4b depicts a respective semi-closed measurement loop. The first part of the measurement loop between the first proximal end 402 and the sensing end 453 is the first metrology chain 4. A second part between the sensing end 453 and the actual object point 25 is provided by a known spatial relationship established by the optical probing 540. The third part between the actual 25 and initial object points 251 is provided by a known spatial relationship established by the measuring path 252. The fourth part 257 between the initial object point 251 and the coupling end 976 of the second metrology chain 9 is provided by a fixed, but unknown, pose difference between the coupling area and the initial object point 251. In the depicted embodiment a direct, point like mechanical coupling between the coupling end 976 and the reference point exists. The fifth, closing part between the coupling end 976 and the second proximal end 902 is provided by the second metrology chain 9.

Many alternatives of the embodiments depicted in FIGS. 3, and 4 exist. A non-exclusive list of alternatives comprises e.g., a second limb structurally and functionally equivalent of a first limb providing metrology grade data. The pose of the reference point and/or the pose change of the coupling area relative to the reference point might be determined by a measurement, in particular a non-contact measurement. Further reference points with known spatial relationship to the initial reference point might be defined. The first and second proximal ends might be connected by a support structure, in particle a substantially rigid support structure. The listed and further alternatives are combinable with each other.

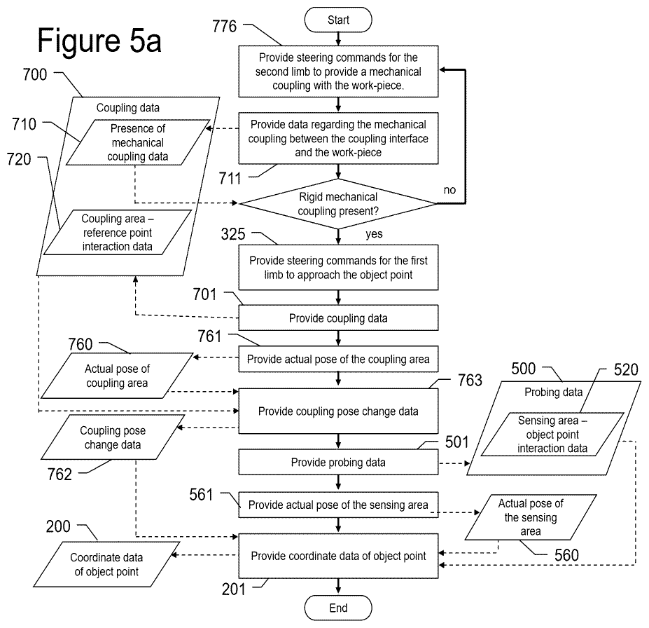

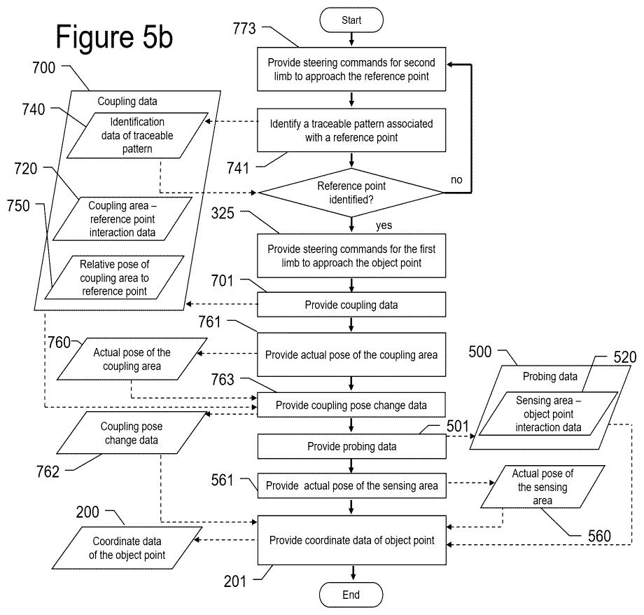

FIG. 5a depicts a flowchart representation of a measurement process with an inventive CMM. Command/flow-lines show as bold and data-lines as dashed arrows. The depicted flowcharts focus on the features and the actual embodiments comprise further, non-depicted elements, in particular command or data elements and/or data transfer lines. Moreover, command or data modules might be depicted in a simplified form due to reasons of clarity and conciseness. In the depicted embodiment the first and second limbs comprise respective kinematic chains to maneuver the sensing and coupling areas.

In the depicted process a mechanical coupling between the workpiece and the coupling interface is established by (i) providing 776 steering commands for the joints of the second limb to provide a mechanical coupling, and (ii) providing 711 data regarding the presence of mechanical coupling 710 between the coupling interface and the workpiece. When the mechanical coupling is present steering commands for the joints of the first limb are provided 325 to approach the object point. The actual measurement comprises (i) providing 701 coupling data 700 comprising interaction information 720 between the coupling area and the reference point, (ii) providing 761 an actual pose 760 of the coupling area, (iii) providing 763 coupling pose change data 762 based on the actual pose 760 of the coupling area and the interaction data 720 between the coupling area and the reference point, (iv) providing 501 probing data 500, comprising interaction information 520 between the sensing area and the object point, (v) providing 561 an actual pose 560 of the sensing area, and (vi) providing 201 coordinate data 200 of the object point based on the actual pose 560 of the sensing area, the probing data 500 and the coupling pose change data 762.

FIG. 5b depicts a flowchart representation of a measurement process with an inventive CMM, where the coupling is provided by a non-contact coupling method. In the depicted process a non-contact coupling between the workpiece and the coupling interface is established by (i) providing 776 steering commands for the joints of the second limb to approach a reference point, and (ii) identifying 741 a traceable pattern associated with the reference point and providing identification data 740 regarding the traceable pattern. When the traceable pattern is identified steering commands for the joints of the first limb are provided 325 to approach the object point. The actual measurement comprises (i) providing 701 coupling data 700 comprising interaction information 720 between the coupling area and the reference point and a relative pose 750 of the coupling area to the reference point, (ii) providing 761 an actual pose 760 of the coupling area, (iii) providing 763 a coupling pose change data 762 based on the actual pose 760 of the coupling area and the relative pose 750 of the coupling area to the reference point, (iv) providing 501 probing data 500 comprising interaction information 520 between the sensing area and the object point, (v) providing 561 an actual pose 560 of the sensing area, and (vi) providing 201 coordinate data 200 of the object point based on the actual pose 560 of the sensing area, the probing data 500 and the coupling pose change data 762.

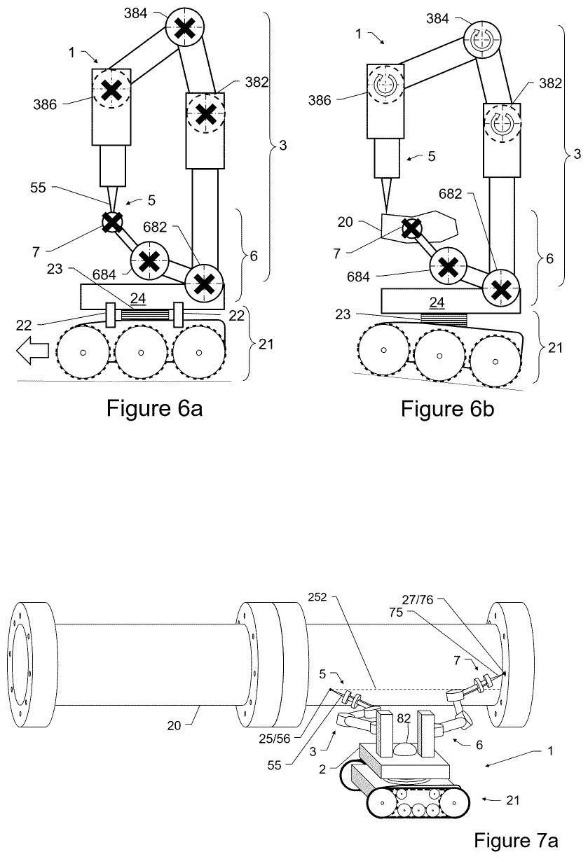

FIG. 6a depicts a schematic CMM 1 mounted to a mobile carrier 21. By way of example the mobile carrier 21 comprises three wheeled axes. The disclosure is not limited to the depicted embodiment. A CMM 1 might be applicable with any reasonable realization of the mobile carrier, a non-exclusive list includes alternative wheel arrangements, tracked, legged, or flying/hovering carriers or even man-portable CMM-s 1.

The mobile carrier 21 and/or the chassis component 24 might comprise vibration dampening elements 23, e.g., pneumatic elements. In the depicted embodiment the first 3 and second limbs 6 are directly connected. I.e., the chassis component 24 is not part of the measurement loop. The chassis component 24 might comprise a support structure providing a rigid connection between the proximal ends of the first 3 and second limbs 6. Such support structures are part of the measurement loop. The mobile carrier 21 and/or the chassis component 24 might comprise fixing elements 22 configured to lock the chassis component 24 to the mobile carrier 21, in particular in a transport mode as depicted. Furthermore, the first 382,384,386 and the second set of joints 682,684 might also be partially, in particular completely as depicted, immobilized in the transport mode. In the depicted embodiment the probe head 5 comprises a tactile sensor 55 and the coupling interface 7 is interlocked with the tactile sensor 55. Different types of interlocking of the first 3 and second limbs 6 are within the sense of the disclosure.

FIG. 6b shows the same CMM 1 performing a measurement in a measurement mode. The chassis component 24 is now connected to the mobile carrier 21 only by the vibration dampening element 23, i.e., the CMM 1 is decoupled from the environment. By way of example the mobile carrier 21 is standing on uneven ground, this is also compensated by the vibration dampening element 23, however the disclosure is equally applicable without such compensation. The first set of joints 382,384,386 exhibit a full mobility in the measurement mode, so far other requirements, in particular requirements of improved precision, does not motivate an immobilization of one or more joints. The second set of joints 682,684 are immobilized to provide an improved accuracy. The coupling interface 7 provides a rigid mechanical coupling with the workpiece 20. The disclosure is not limited to the depicted embodiment and might be equally applied if the coupling interface 7 does not provide a rigid mechanical coupling to the workpiece but provides a coupling data comprising interaction information between the coupling area and a reference point, in particular a relative pose of the coupling area to the reference point.

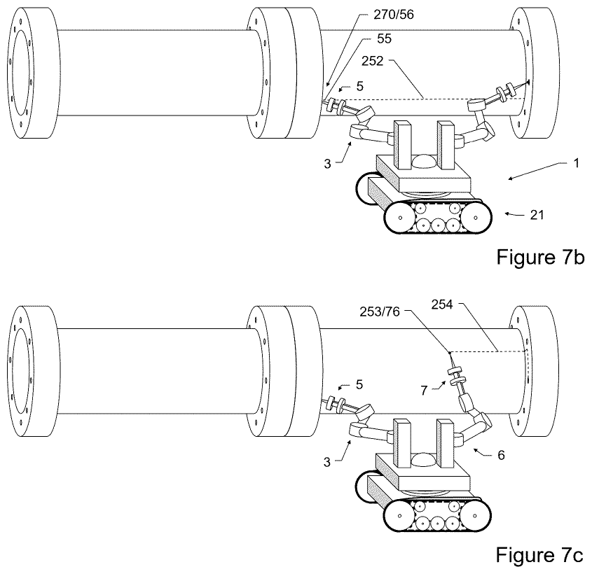

FIG. 7a depicts a pipe as large workpiece 20 to be inspected by a mobile CMM 1. A support structure 2 connecting the first 3 and the second limbs 6 is mounted on a mobile chassis 21, depicted as a track drive. The support structure 2 is a part of the measurement loop, the mobile chassis 21 is, however, not comprised by the measurement loop. The depicted first 3 and second limbs 6 comprise identical structural and functional elements and distinguished by utilization only. Alternatively, the first 3 and second limbs 6 might be substantially similar. By way of example both limbs comprise respective tactile sensors 55,75. The tactile sensor 55 of the first limb 3 is used as probing element 5 providing probing data, whereas the sensing area 56, depicted as a ruby sphere, is guided along the measurement path 252. The tactile sensor 75 of the second limb 6 is used as coupling interface 7 providing coupling data, i.e., the coupling area 76 maintains contact with a reference point 27 and a relative pose change between the coupling area 76 and the reference point is 27 provided. The probing element 5 and coupling interface 7 might also comprise further physical components providing a rigid mechanical coupling to the workpiece 20. The depicted CMM 1 also comprises further sensors 82, e.g., a camera to provide at least a coarse localization against the workpiece 20. Providing further similar or alternative sensors is within the sense of the disclosure.

FIG. 7b depicts a transition to a next measurement phase. The first phase is completed and the measuring path 252 has reached its endpoint. The ruby sphere 56 of the tactile sensor 55 maintains contact with a further reference point 270. In other words, the first limb 3 will provide the functionalities “of the second limb”. Since the CMM 1 is decoupled from the mobile chassis 21, i.e., the metrology loop is not closed through the mobile chassis 21, a repositioning of a CMM 1 is also possible.

FIG. 7c depicts the next measurement phase wherein the second limb 6 is guiding the coupling area 76 along a further measurement path 253 of the next phase and providing coordinate data of further object points 254. I.e., the second limb 6 provides the functionalities of the “first limb”. The probing element 5 and the first limb 3 provide the further coupling data. By performing a plurality of such transitions, a large workpiece 20 can be accurately measured. In the depicted embodiment boreholes 202 are used as references. The workpiece 20 might have designated coupling counterparts, e.g., a one-ball coupling, three-ball coupling, a jig, or an electromagnetic coupling counterpart. Such coupling counterparts might have identifiers which can be detected by the probing element 5, and/or the coupling interface 7 and/or one or more further sensors 82.

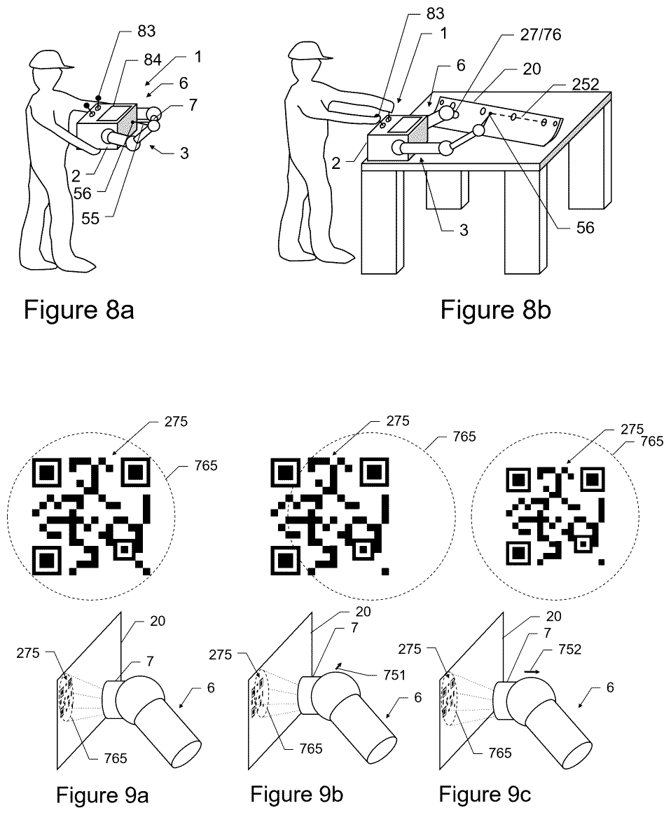

FIG. 8a depicts a lightweight, man portable CMM 1 in a transport mode. The depicted CMM 1 comprises a support structure 2 connecting the first 3 and second limbs 6, and featuring input elements 83 to receive operator input, depicted as a pair of joysticks, and output elements 84, depicted as a screen. The first limb 3 has a plurality of joints and links. A tactile sensor 55, with a ruby sphere as sensing area 56, is mounted on the first limb 3. The second limb 6 is substantially similar to the first limb 3. A coupling interface 7 configured to provide a releasable rigid mechanical coupling via electromagnetic elements is mounted on the second limb 6. In the depicted transport mode, the first 3 and second limbs 6 are interlocked by the coupling element 7. FIG. 8b depicts the same man portable CMM 1 in a measurement mode measuring e.g., a ferromagnetic workpiece 20. A releasable rigid mechanical coupling is established between the coupling area 76 and a reference point 27 located on the workpiece 20. I.e., the pose of the workpiece 20 is locked to that of the second limb 6. The second limb 6 might also be locked during the measurement. Alternatively, the second limb 6 might provide controlled pose change for the workpiece 20. As a result, a semi-closed metrology loop is provided through the second limb 6, the support structure 2, the first limb 3 and the workpiece 20. The operator, via the input interface 83, provide commands regarding a desired movement of the sensing area 56 along a measurement path 252. Due to the semi-closed metrology loop, in particular when the second limb 6 is locked, the accuracy in deriving the pose of the sensing area 56 determines the accuracy of the measurement.

Aspects of the embodiments of the mobile CMM of FIGS. 6 and 7 are combinable with the aspect of the portable CMM of FIG. 8. Moreover, a CMM might also be transported by a legged robot or an UAV as mobile carrier and/or transport vehicle. Neither the probing element nor the coupling interface is limited to the depicted embodiments. Alternative components, working principles or utilization methods are within the sense of the disclosure.

FIG. 9 depicts a method of deriving the coupling pose change data by a coupling interface 7 based on non-contact principle. The coupling interface is located at the coupling end of the second limb 6. By way of example the reference point on the workpiece 20 is associated with a QR-code as traceable pattern 275. The disclosure is applicable in combination with patterns different from QR-codes. The pattern might be a text, an area with different reflectivity, surface roughness. The pattern might also be a functional feature of the workpiece 20, e.g., one or more drill holes and/or screw heads, and/or edges and/or corners. The disclosure is applicable with any suitable combinations or alternatives of the above non-exclusive list.

The depicted coupling interface 7 is configured to acquire imaging data from a field of view 765, in particular camera images. The coupling pose change data is based on the relative position and/or motion of the traceable pattern 275 in the field of view 765. FIG. 9 depicts some examples relative positions. The bottom row shows the second limb 6 relative to the workpiece 20. The top row shows the pattern 275 in the field of view 765. In FIG. 9a the pattern 275 is in a first alignment to the field of view 765. Since the disclosure require only the determination of a relative pose change of the coupling area to the reference point, many alternative alignments are possible as first alignments. FIG. 9b depicts a situation, where a relative lateral movement 751 between the workpiece 20 and the coupling interface 7 took place. As a result, the pattern 275 moved relative to the field of view 765. FIG. 9c depicts an example wherein the distance has changed 752 between the workpiece 20 and the coupling interface 7. As a result, the size of the pattern 275 relative to the field of view 765 has changed. Based on the image data the coupling pose change data can be determined. Relative rotations have the respective effects.

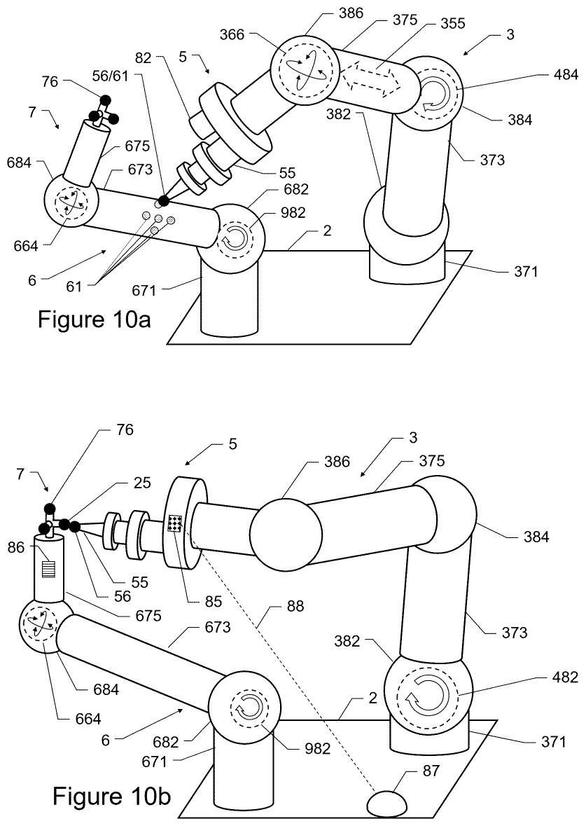

FIG. 10a depicts a schematic step from a reference-free calibration using a calibration object 61 arranged on the second limb 6 as internal calibration object. The probing element 5 in the depicted embodiment comprises a tactile sensor 55 with a ruby sphere as sensing area 56. The probing element 5 also has a visual sensor 82 arranged to it, said visual sensor 82 might be a positioning aid, e.g., by providing visual data regarding the pose of the sensing area 56 and the workpiece. The visual sensor 82 can also be a metrology grade sensor providing coordinate data by non-tactile measurements. The first limb 3 is mounted on a support structure 2 and comprises the first set of joints 382,384,386 and links 371,373,375. For transparency reasons only a single first drive unit 484, a single joint sensor unit 366, and a single sensor 355 associated with a link 375 have been depicted. The first limb 3 provides a respective metrology chain with the required sensors 355,366. Embodiments, wherein the first limb 3 comprises a kinematic chain to provide a set pose of the probe are advantageous. The first limb calibration parameters might comprise free parameters to be determined with respect to the sensor data provided by the sensors 355,366. The depicted degrees-of-freedom of the sensor and drive units serve illustrative purposes and shall not be interpreted in a limiting manner. Neither is the disclosure limited to the depicted arrangement of the first limb 3. The second limb 6 is mounted on the support structure 2 in a different position than the first limb 3. Alternative embodiments, wherein the first 3 and second limbs 6 comprise common components are also within the sense of the disclosure.

The depicted second limb 6 comprises the second set of joints 682,684 and links 671,673,675. For transparency reasons only a single second drive unit 982 and a single joint sensor unit 664 have been depicted, however the second limb 6 provides the respective metrology chain. A coupling interface 7 with a coupling area 76, depicted as a three-ball gauge, is arranged to the second limb 6. The link 673 comprises a calibration pattern with a plurality of calibration objects 61 in a known spatial arrangement. The depicted arrangement is advantageous as the joint 682 provides a plurality of calibration poses for the calibration objects with a pose uncertainty arising from a single joint. I.e., the pose accuracy of the calibration object 61 might exceed that of the sensing area 56. Arranging the calibration object to a link farther from the support structure 2 provides a benefit in increased flexibility. The disclosure is not limited to any specific design.

The depicted calibration comprises the step of contacting the sensing area 56 to the calibration object 61. By recording the sensor data, e.g., from the joint sensor units 366, the measured pose of the sensing area 56, i.e., the first calibration data, can be derived utilizing first limb calibration parameters. The second metrology chain provides the second calibration data, i.e., an actual pose of the calibration object 61 based on the second limb calibration parameters. The calibration parameters can be updated based on a deviation between the actual pose of the calibration object 61 and the measured pose of the sensing area 56. A complete calibration procedure might involve a set of single calibration measurements with a plurality of poses for the calibration object 61. A similar calibration is applicable to non-contact sensor.

FIG. 10b depicts a schematic step from a method of calibrating the limb calibration parameters by measuring the pose of an object point 25 associated with the coupling area 76 of the coupling interface 7 by the probing element 5. The probing element 5 in the depicted embodiment comprises a tactile sensor 55 with a ruby sphere as sensing area 56. The probing element 5 comprises a first six degrees-of-freedom trackable area 85, depicted as a visual marker, associated with the pose of the sensing area 56. The second limb 6 comprises a second six degrees-of-freedom trackable area 86, depicted as a visual marker, associated with the pose of the coupling area 76. A non-contact tracking unit 87, depicted as a laser tracker, is mounted on the support structure 2. The tracking unit 87 tracks the markers 85,86 using a laser beam 88 to determine the pose of the sensing 56 and the coupling areas 76. The laser tracker 87 might provide supplementary pose information regarding the pose of the sensing 56 or coupling area 76. The depicted calibration method might also be used to provide update for a set calibration parameter of the laser tracker 87.

The first limb 3 is mounted on the support structure 2 and comprises the first set of joints 382,384,386 and links 371,373,375. For transparency reasons only a single first drive unit 482 and no joint sensor units are depicted. The depicted second limb 6 comprises the second set of joints 682,684 and links 671,673,675. For transparency reasons only a single second drive unit 982 and a single joint sensor unit 664 have been depicted. A coupling interface 7 with a coupling area 76, depicted as a three-ball gauge, is arranged to the second limb 6. An object point 25 is associated with the pose of the coupling interface 76.

The depicted calibration comprises of bringing the coupling interface 76 to a calibration pose. The second metrology chain provides a second calibration data based on the sensor data of the second set of sensors, and the second limb calibration parameters. Based on the sensor data of the first set of sensors the measured pose of the sensing area 56, i.e., the first calibration data, can be derived using the first limb calibration parameters.

Alternative embodiments, in particular, wherein the coupling interface 7 and the probe 5 are interlocked, are within the sense of the disclosure. Such embodiments are especially beneficial as they enable a continuous constrained movement, wherein the pose of the coupling area 76 and sensing area 25 could be derived for a plurality of first and/or second limb movements. One of the limbs 3,6 might provide the driving force and at least a part of the joints 382,384,386,682,684 of the other limb might be idling.

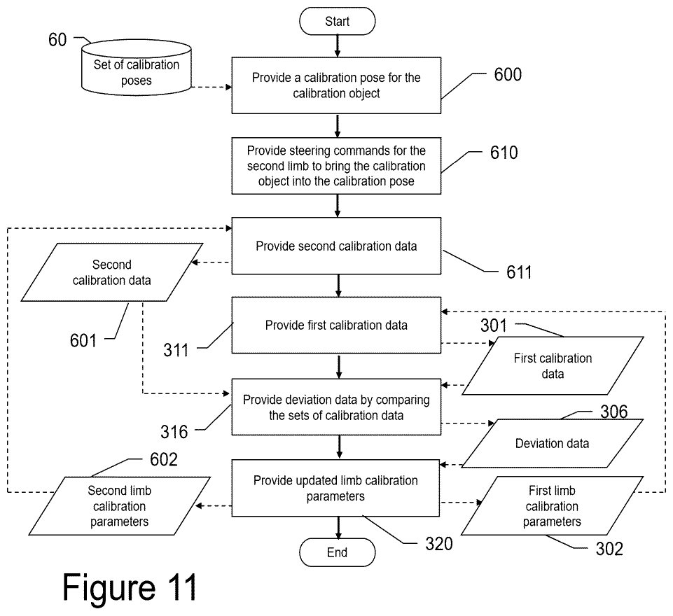

FIG. 11 depicts a flowchart representation of the calibrations of FIG. 10. In the first step a probe calibration pose, with associated nominal coordinate data, is selected 600 from a stored set of probe calibration poses 60. Steering commands for the respective joints of the second limb are provided 610 to bring the calibration object into the calibration pose. A second calibration data 601 of the calibration object is provided 611 by the second metrology chain utilizing the second limb calibration parameters 602. A first calibration data 301 of the calibration object is then provided 311 by measuring it with the probing element, i.e., by the first metrology chain, utilizing the first limb calibration parameters 302. The deviation data 306 is provided by comparing 316 the first 301, and the second calibration data 601. Based on the deviation data 306 updated first 302 and second limb calibration parameters 602 are provided 320. It is clear for the skilled person, that a typical calibration involves a plurality of calibration poses. Cases where the deviation data comprises data from a plurality of calibration object poses and/or different parts of the calibration object are within the sense of the disclosure. Other reasonable variations of the calibration, in particular wherein measured coordinate data regarding the same calibration object pose are provided by alternative joint poses of the first set of joints, are also within the sense of the disclosure. Furthermore, a CMM might allow a derivation of further calibration object poses based on model calculations or measurements.

The depicted calibration method assumed that the second limb comprises a kinematic chain, and the calibration poses are provided by the said kinematic chain. It is clear to the skilled person that the disclosure is not limited to this embodiment. The disclosure can be realized by embodiments e.g., wherein both limbs are driven or wherein a part of the joints idling.

Although aspects are illustrated above, partly with reference to some specific embodiments, it must be understood that numerous modifications and combinations of different features of the embodiments can be made. All of these modifications lie within the scope of the appended claims.

1. A coordinate measuring machine, CMM, for determining spatial coordinate data of an object point on a workpiece, the CMM comprising a first limb and a probing element, wherein:
the first limb comprises a first set of joints, a first set of links and connects the probing element at a sensing end to a first proximal end,
the probing element is configured to provide probing data comprising interaction information between a sensing area of the probing element and the object point, and the CMM is configured to determine an actual pose of the sensing area,
wherein the CMM comprises a second limb and a coupling interface, wherein:
the second limb comprises a second set of links and/or a second set of joints, and connects the coupling interface at a coupling end to a second proximal end, wherein the second proximal end is mechanically constrained to the first proximal end,
the coupling interface is configured to provide coupling data comprising interaction information between a coupling area of the coupling interface and a reference point, wherein the object point has a defined spatial relationship to the reference point, in particular wherein the reference point is comprised by the workpiece, and
the CMM is further configured:
to determine an actual pose of the coupling area,
to provide coupling pose change data based on the actual pose of the coupling area and the coupling data, and
to provide the coordinate data of the object point based on the probing data, the actual pose of the sensing area, and the coupling pose change data.

2. The CMM according to claim 1, wherein the first and the second proximal ends coincide, or a substantially rigid support structure connects the first and second proximal ends.

3. The CMM according to claim 1, wherein each joint of the first set of joints comprises:
a proximal side connected to the first proximal end by a respective proximal portion of the first limb,
a distal side connected to the probing element by a respective distal portion of the first limb, and
a joint sensor unit configured to provide first joint sensor data regarding a relative pose and/or pose change between the proximal and distal sides of the joint;
each joint of the second set of joints comprises:
a proximal side connected to the second proximal end by a respective proximal portion of the second limb,
a distal side connected to the coupling interface by a respective distal portion of the second limb, and
a joint sensor unit configured to provide second joint sensor data regarding a relative pose and/or pose change between the proximal and distal sides of the joint;
wherein:
a subset of the first set of joints comprises a first drive unit configured to provide the relative pose and/or the pose change between the proximal and distal sides of the joint, the CMM is configured:
to access computer generated or operator input data regarding a desired pose or movement of the sensing area,
to provide steering commands to the first drive unit based on the desired pose or movement and the actual pose of the sensing area
a subset of the second set of joints comprises a second drive unit configured to provide the relative pose and/or the pose change between the proximal and distal sides of the joint, and
the CMM is configured:
to access computer generated or operator input data regarding a desired pose or movement of the coupling area, and
to provide steering commands for the second drive unit based on the desired pose or movement and the actual pose of the coupling area.

4. The CMM according to claim 3, wherein each joint of the first and second sets of joints is a rotary joint and each link has a substantially cylindrical shape, wherein:
the pose change between the respective proximal and the distal sides is a rotation around one or more axes,
the respective joint sensor data comprises rotation angle data, and
the probing element comprises a tactile sensor, and the probing data comprises contact and/or friction force information between the sensing area and the object point.

5. The CMM according to claim 1, being configured:
to store first and second limb calibration parameters
to determine the actual pose of the sensing area based on the first limb calibration parameters, and
to determine the actual pose of the coupling area based on the second limb calibration parameters.

6. The CMM according to claim 5 comprising an internal calibration object and reference-free calibration functionality comprising:
providing a calibration pose of the internal calibration object,
providing first calibration data comprising spatial coordinates of the internal calibration object in the calibration pose based on the first limb calibration parameters,
providing second calibration data comprising spatial coordinates of the internal calibration object in the calibration pose based on the second limb calibration parameters,
providing deviation data based on the first and the second calibration data, in particular wherein the deviation data is proportional to a difference of the spatial coordinates, and updating the first and/or the second limb calibration parameters based on the deviation data,
wherein:
a plurality of calibration poses of the internal calibration object is provided,
the reference-free calibration functionality further comprises mechanically interlocking the first and second limbs.

7. The CMM according to claim 1, wherein:
the coupling interface is configured to provide a rigid mechanical coupling between the coupling area and the reference point,
the coupling data comprises data regarding a presence of the rigid mechanical coupling, the coupling interface is configured to grip the workpiece, and
the CMM is configured provide steering commands for the second limb based on the actual pose of the coupling area and relative coordinate data of the reference point.

8. The CMM according to claim 7, wherein the coupling interface comprises a first locking element and the workpiece comprises a second locking element associated with the reference point, wherein the first and second locking elements are configured to provide a releasable, substantially rigid mechanical coupling,
in particular wherein providing the rigid mechanical coupling between the coupling area and the reference point further causes a reduced mobility for a part of the second set of joints, in particular causes an immobile state for each joints in the second set of joints.

9. The CMM according to claim 1, wherein:
the workpiece comprises a traceable pattern or an optically traceable pattern or a QR-code, wherein the pose of the reference point is associated with the traceable pattern, the CMM is configured to:
identify the traceable pattern, and
provide a relative pose of the coupling area to the reference point; and
the coupling data comprises the relative pose of the coupling area to the reference point.

10. The CMM according to claim 1, comprising a non-contact tracking unit for determining a pose of the sensing and/or the coupling area, wherein:
the non-contact tracking unit is configured for determining the pose based on laser and/or image based tracking, and
the first limb and/or the probing element comprises a first six degrees-of-freedom trackable area associated with the pose of the sensing area, and/or
the second limb and/or the coupling interface comprises a second six degrees-of-freedom trackable area associated with the pose of the coupling area.

11. The CMM according to claim 1, being configured to be mounted to a mobile chassis being configured to transport the CMM from a first location to a second location, wherein the CMM exhibits a transport mode and a measurement mode, wherein:
in the transport mode a part of the first and/or second limb is immobile or the first and second limbs are interlocked, and the CMM is locked to the mobile chassis, and in the measurement mode, the CMM is mechanically decoupled from the mobile chassis such that mechanical vibrations between the mobile chassis and the CMM are dampened.

12. A method of determining spatial coordinate data of an object point on a workpiece by a CMM according to claim 1, the method comprising:
providing an actual pose of a sensing area associated with a sensing end of a first limb comprising a first set of links and a first set of joints,
providing probing data comprising interaction information between the sensing area and the object point,
providing an actual pose of a coupling area associated with a coupling end of a second limb comprising a second set of links and/or a second set of joints,
providing coupling data comprising interaction information between the coupling area and a reference point, in particular a reference point on the workpiece,
deriving coupling pose change data based on the actual pose of the coupling area and the coupling data, and
providing coordinate data of the object point based on the actual pose of the sensing area, the probing data and the coupling pose change data.

13. The method according to claim 12, further comprising providing rigid mechanical coupling between the coupling area and the reference point, wherein:
the mechanical coupling is provided by gripping the workpiece with the second limb and/or the coupling interface, and/or
the method further comprises mechanically decoupling the workpiece from the environment by lifting the workpiece by the coupling interface, and/or
the method further comprises reducing the mobility of the second limb.

14. The method according to claim 12, comprising a further measurement phase, wherein the further measurement phase comprises:
selecting an object point from a set of measured object points as a further reference point,
providing the actual pose of the sensing area relative to the further reference point,
providing further coupling data comprising interaction information between the sensing area and the further reference point,
deriving further coupling pose change data based on the actual pose of the sensing area and the further coupling data,
providing the actual pose of the coupling area,
providing further probing data comprising interaction information between the coupling area and a further object point on the workpiece, and
providing coordinate data of the further object point based on the actual pose of the coupling area, the further probing data and the further coupling pose change data.

15. A method of determining spatial coordinate data of an object point on a workpiece by a CMM according to claim 11, the method comprising:
providing an actual pose of a sensing area associated with a sensing end of a first limb comprising a first set of links and a first set of joints,
providing probing data comprising interaction information between the sensing area and the object point,
providing an actual pose of a coupling area associated with a coupling end of a second limb comprising a second set of links and/or a second set of joints,
providing coupling data comprising interaction information between the coupling area and a reference point, in particular a reference point on the workpiece,
deriving coupling pose change data based on the actual pose of the coupling area and the coupling data, and
providing coordinate data of the object point based on the actual pose of the sensing area, the probing data and the coupling pose change data.

16. A computer program product comprising a processor and computer code stored in a non-transitory computer-readable medium, which, when executed by a computing unit and/or a controller, causes an automatic execution of the computational steps of the method according to claim 12.

17. A computer program product comprising a processor and computer code stored in a non-transitory computer-readable medium, which, when executed by a computing unit and/or a controller, causes an automatic execution of the computational steps of the method according to claim 14.
